(19) United States
(12) Patent Application Publication
(10) Pub. No.: US 2024/0002566 A1
(43) Pub. Date: Jan. 4, 2024

(54) OPTICAL MEMBER AND METHOD FOR PRODUCING SAME

(71) Applicant: KANEKA CORPORATION, Osaka (JP)

(72) Inventors: Toshiaki Ezaki, Osaka (JP); Kazunori Saegusa, Osaka (JP); Keisuke Hatano, Osaka (JP); Keita Hirai, Osaka (JP); Riru Nishikawa, Osaka (JP)

(73) Assignee: KANEKA CORPORATION, Osaka (JP)

(21) Appl. No.: 18/368,766

(22) Filed: Sep. 15, 2023

Related U.S. Application Data
(63) Continuation of application No. PCT/JP2022/011370, filed on Mar. 14, 2022.

(30) Foreign Application Priority Data
Mar. 16, 2021 (JP) 2021-042744

(51) Int. Cl. C08F 220/14

(52) U.S. Cl. CPC C08F 220/14; C08F 2800/10; C08F 2810/00; B29C 71/02

(57) ABSTRACT

An optical member and a method for producing this optical member are provided. The optical member is composed of an injection molded article. The injection molded article includes a glutarimide resin that contains a glutarimide unit having an imidocarbonyl group provided by the imidization of a carbonyl group deriving from (meth)acrylate ester monomer, a repeat unit deriving from (meth)acrylate ester monomer, and a repeat unit deriving from aromatic vinyl monomer. The glutarimide resin has an orientation birefringence of −0.5×10⁻³ to 0.5×10⁻³, a photoelastic constant of −3.0×10⁻¹² Pa⁻¹ to 3.0×10⁻¹² Pa⁻¹, and a glass transition temperature of at least 125° C. The average value of the phase difference of the optical member is not more than 20 nm.

### TECHNICAL FIELD

One or more embodiments of the present invention relate to an optical member having a low retardation and a manufacturing method thereof.

### BACKGROUND

In optical members such as optical lenses including virtual space (VR) lenses and augmented reality (AR) lenses and in-vehicle displays, it is required to use a material having a small retardation for improving image quality. On the other hand, a material having a small retardation is conventionally used for polarizer protective films or the like. For example, Patent Document 1 discloses a polarizer protective film having a reduced retardation by using a glutarimide resin having a glutarimide unit.
Patent Document 1: PCT International Publication No. WO 2005/054311

However, even when an optical member obtained by injection molding of a glutarimide resin has low retardation in the initial stage of molding, the optical member absorbs moisture in air during storage at room temperature, which may result in an increase in the retardation over time.

In order to solve the above, one or more embodiments of the present invention provide an optical member having low retardation in initial stage of molding after injection molding and suppressing an increase in the retardation over time, and a manufacturing method thereof.

### SUMMARY

An optical member according to one or more embodiments of the present invention is an optical member formed of an injection molded article, in which the injection molded article includes a glutarimide resin; the glutarimide resin includes a repeating unit represented by the following general formula (1), a repeating unit represented by the following general formula (2), and a repeating unit represented by the following general formula (3); the glutarimide resin has an orientation birefringence of −0.5×10⁻³ or more and 0.5×10⁻³ or less, a photoelastic constant of −3.0×10⁻¹² Pa⁻¹ or more and 3.0×10⁻¹² Pa⁻¹ or less, and a glass transition temperature of 125° C. or more; and the optical member has an average value of retardation of 20 nm or less:

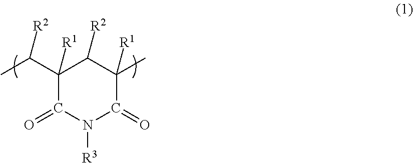

in the general formula (1), R¹ and R² each independently represent a hydrogen atom or an alkyl group having 1 to 8 carbon atoms, and R³ represents a hydrogen atom, an alkyl group having 1 to 18 carbon atoms, a cycloalkyl group having 3 to 12 carbon atoms, or an aryl group having 6 to 10 carbon atoms;

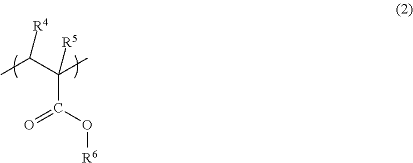

in the general formula (2), R⁴ and R⁵ each independently represent a hydrogen atom or an alkyl group having 1 to 8 carbon atoms, and R⁶ represents an alkyl group having 1 to 18 carbon atoms, a cycloalkyl group having 3 to 12 carbon atoms, or an aryl group having 6 to 10 carbon atoms; and

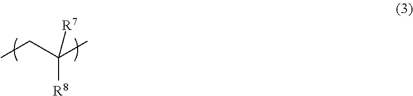

in the general formula (3), R⁷ represents a hydrogen atom or an alkyl group having 1 to 8 carbon atoms, and R⁸ represents an aryl group having 6 to 10 carbon atoms.

A manufacturing method of an optical member according to one or more embodiments of the present invention is a manufacturing method of the above-described optical member, the method including reacting a copolymer including a repeating unit represented by the following general formula (2) and a repeating unit represented by the following general formula (3), with an imidizing agent to obtain a glutarimide resin, injection molding a glutarimide resin composition containing the glutarimide resin to obtain an injection molded article, and annealing the injection molded article:

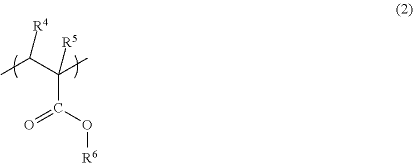

in the general formula (2), R⁴ and R⁵ each independently represent a hydrogen atom or an alkyl group having 1 to 8 carbon atoms, and R⁶ represents an alkyl group having 1 to 18 carbon atoms, a cycloalkyl group having 3 to 12 carbon atoms, or an aryl group having 6 to 10 carbon atoms; and

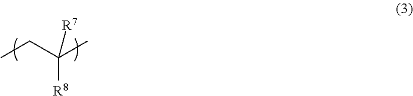

in the general formula (3), R⁷ represents a hydrogen atom or an alkyl group having 1 to 8 carbon atoms, and R⁸ represents an aryl group having 6 to 10 carbon atoms.

### Effects of the Invention

According to one or more embodiments of the present invention, it is possible to provide an optical member in which retardation in a molding initial stage after injection molding is low and an increase in the retardation over time is suppressed. Further, by the manufacturing method of one or more embodiments of the present invention, an optical member having a low retardation in the initial stage of molding and having an increase in the retardation over time suppressed can be manufactured by injection molding.

### BRIEF DESCRIPTION OF THE DRAWINGS

FIG. 1 is a schematic front view of an optical lens;

FIG. 2 is a schematic rear view of the optical lens;

FIG. 3 is a schematic side view of the optical lens;

FIG. 4 is a schematic front view of an in-vehicle display;

FIG. 5 is a schematic rear view of the in-vehicle display; and

FIG. 6 is a schematic cross-sectional view of the in-vehicle display taken along the I-I direction.

### DETAILED DESCRIPTION OF THE EMBODIMENTS

The inventors of one or more embodiments of the present invention conducted extensive investigations in order to suppress an increase in retardation over time of an injection molded optical member or the like. As a result, it was found that by using a glutarimide resin that contains specific repeating units of the following general formulae (1) to (3), that has orientation birefringence and photoelastic constant close to zero, and that has a glass transition temperature of 125° C. or higher, the retardation in the initial stage of molding of the optical member can be made low and an increase of the retardation over time can be suppressed. Such an effect is particularly remarkable in the case of an optical member having a shape in which stress is easily generated, such as a shape with a thick thickness, a shape with non-uniform thickness, a shape with no isotropy, and a shape with a curved surface. In particular, it was found that an optical member obtained by injection molding a glutarimide resin having an orientation birefringence and photoelastic constant close to zero and having a glass transition temperature of 125° C. or higher, the glutarimide resin being obtained by reacting a copolymer of a (meth)acrylic acid ester-based monomer and an aromatic vinyl-based monomer with an imidizing agent such as monomethylamine or ammonia, has a low retardation in the initial stage of molding and an increase of the retardation over time suppressed, even when the optical member has a shape in which stress is easily generated, for example, a shape with a thick thickness, a shape with non-uniform thickness, a shape with no isotropy, or a shape with a curved surface. Here, the “curved surface” means that a curved surface portion such as a concave portion or a convex portion exists on the image display surface of the optical member.

### (Optical Member)

The glutarimide resin contains specific repeating units represented by the following general formulae (1) to (3). The repeating unit represented by the general formula (2) is a unit derived from a (meth)acrylic acid ester-based monomer, and the repeating unit represented by the general formula (3) is a unit derived from an aromatic vinyl-based monomer. The repeating unit represented by the general formula (1) is a glutarimide unit and has an imidocarbonyl group obtained by imidizing a carbonyl group derived from a (meth)acrylic acid ester-based monomer. When the glutarimide resin has such a repeating unit, the orientation birefringence and the photoelastic constant approach zero and heat resistance is increased.

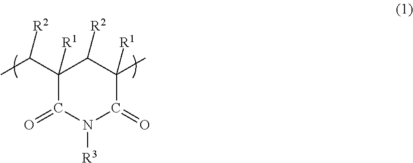

In the general formula (1), R¹ and R² each independently represent a hydrogen atom or an alkyl group having 1 to 8 carbon atoms, and R³ represents a hydrogen atom, an alkyl group having 1 to 18 carbon atoms, a cycloalkyl group having 3 to 12 carbon atoms, or an aryl group having 6 to 10 carbon atoms. In the general formula (1), preferably, R¹ and R² are each independently a hydrogen atom or a methyl group, R³ is a hydrogen atom, a methyl group or a cyclohexyl group, and more preferably, R¹ is a methyl group, R² is a hydrogen atom, and R³ is a hydrogen atom or a methyl group.

The repeating unit represented by the general formula (1) may be a single type, or may contain a plurality of different types which differ from one another in R¹, R², and R³.

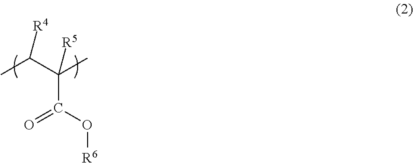

In the general formula (2), R⁴ and R⁵ each independently represent a hydrogen atom or an alkyl group having 1 to 8 carbon atoms, and R⁶ represents an alkyl group having 1 to 18 carbon atoms, a cycloalkyl group having 3 to 12 carbon atoms, or an aryl group having 6 to 10 carbon atoms.

Examples of the repeating unit represented by the general formula (2) include a unit derived from an alkyl (meth)acrylate-based monomer. Examples of the alkyl (meth)acrylate-based monomer include methyl (meth)acrylate, ethyl (meth)acrylate, butyl (meth)acrylate, isobutyl (meth)acrylate, t-butyl (meth)acrylate, benzyl (meth)acrylate, and cyclohexyl (meth)acrylate. In the present disclosure, “(meth)acrylic acid” may be methacrylic acid or acrylic acid. The “(meth)acrylate” may be methacrylate or acrylate. The repeating unit represented by the general formula (2) may be also a unit derived from an imidizable monomer such as an acid anhydride such as maleic anhydride or a half ester of the acid anhydride and a linear or branched alcohol having 1 to 20 carbon atoms; or α,β-ethylenically unsaturated carboxylic acids such as acrylic acid, methacrylic acid, maleic acid, maleic anhydride, itaconic acid, itaconic anhydride, crotonic acid, fumaric acid, and citraconic acid. Among them, from the viewpoint of high transparency, low birefringence, and easy availability at low cost, it is particularly preferable that R⁴ represents a hydrogen atom, R⁵ represents a methyl group, and R⁶ represents a methyl group. That is, a unit derived from methyl methacrylate is particularly preferable.

The repeating unit represented by the general formula (2) may be a single type or may contain a plurality of different types which differ from one another in R⁴, R⁵, and R⁶.

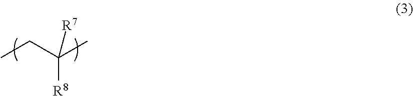

In the general formula (3), R⁷ represents a hydrogen atom or an alkyl group having 1 to 8 carbon atoms, and R⁸ represents an aryl group having 6 to 10 carbon atoms. Examples of the repeating unit represented by the general formula (3) include units derived from aromatic vinyl monomers such as styrene, α-methylstyrene, vinyl toluene, and vinyl naphthalene. Among them, from the viewpoint of excellent thermal stability and easy adjustment of the orientation birefringence, it is particularly preferable that R⁷ represents a hydrogen atom and R⁸ represents a phenyl group. That is, a unit derived from styrene is particularly preferable.

The repeating unit represented by the general formula (3) may be a single type or may contain a plurality of different types which differ from one another in R⁷ and R⁸.

In the glutarimide resin, it is preferable that the repeating unit represented by the general formula (2) is a unit derived from methyl methacrylate, the repeating unit represented by the general formula (3) is a unit derived from styrene, and the repeating unit represented by the general formula (1) is a glutarimide unit and has an imidocarbonyl group resulting from imidization of the carbonyl group derived from methyl methacrylate. When the glutarimide resin has such repeating units, the orientation birefringence and the photoelastic constant are close to zero, and the heat resistance is easily improved.

The glutarimide resin has an orientation birefringence of −0.5×10⁻³ or more and 0.5×10⁻³ or less, and substantially has no orientation birefringence. When the orientation birefringence is outside the above range, the retardation of the optical member obtained by injection molding of the glutarimide resin tends to increase. The orientation birefringence may be −0.2×10⁻³ or more and 0.2×10⁻³ or less, or from −0.1×10⁻³ or more and 0.2×10⁻³ or less.

In the present specification, unless otherwise specified, the term “orientation birefringence” means birefringence that occurs when the glutarimide resin is stretched by 100% at temperature higher than the glass transition temperature of the glutarimide resin by 5° C. The orientation birefringence (Δnor) is specifically defined by Δnor=nx−ny=Re/d. nx denotes a refractive index in the stretching axis (x-axis) direction of the test piece, ny denotes a refractive index in the axis (y-axis) direction orthogonal to the stretching axis of the test piece on the surface of the test piece, Re denotes in-plane retardation of the test piece, and d denotes a thickness of the test piece. In one or more embodiments of the present invention, the orientation birefringence (Δnor) can be measured with a birefringence meter, as described below.

The glutarimide resin has a photoelastic constant of −3.0×10⁻¹² Pa⁻¹ or more and 3.0×10⁻¹² Pa⁻¹ or less, and the photoelastic constant is substantially close to zero. When the photoelastic constant is outside the above range, the retardation of the optical member obtained by injection molding the glutarimide resin tends to increase over time. The photoelastic constant may be from −2.0×10⁻¹² Pa⁻¹ to 2.0×10⁻¹² Pa⁻¹ or from −1.5×10⁻¹² Pa⁻¹ to 1.0×10⁻¹² Pa⁻¹.

When an external force is applied to an isotropic solid to cause a stress (ΔF), the isotopic solid temporarily exhibits optical anisotropy and shows birefringence (Δn). The ratio of the stress and the birefringence is termed photoelastic coefficient (c) and is represented by c=Δn/ΔF. In one or more embodiments of the present invention, as described below, the photoelastic coefficient can be measured by Senarmont method at a wavelength of 586.4 nm, 23±2° C., and 50±5% RH (relative humidity).

The glutarimide resin may have a glass transition temperature of 125° C. or higher, 130° C. or higher, 135° C. or higher, 140° C. or higher, or 145° C. or higher. When the glass transition temperature is within the above-mentioned range, the optical member obtained by injection molding of the glutarimide resin has high heat resistance, and in the optical member, strain or the like is unlikely to occur, and stable optical characteristics are easily obtained.

From the viewpoint of obtaining an optical member having excellent heat resistance and stable optical characteristics, the glutarimide resin may have a 5% weight reduction temperature of 350° C. or higher, 365° C. or higher, or 375° C. or higher. In one or more embodiments of the present invention, the 5% weight reduction temperature is measured by thermogravimetric analysis (TGA).

The glutarimide resin may have an imidization proportion of 40% or more and 70% or less, 45% or more and 65% or less, 50% or more and 65% or less, or 50% or more and 60% or less. When the imidization proportion is within the above-mentioned range, the optical member obtained by injection molding of the glutarimide resin has a low retardation in the initial stage of molding, an increase in the retardation over time is easily suppressed, and heat resistance, transparency and processability are also excellent.

In the glutarimide resin, R³ may be a methyl group in the general formula (1), from the viewpoint of effectively suppressing the optical member from absorbing moisture. Such a glutarimide resin can be obtained by using monomethylamine as an imidizing agent described below. In this case, the glutarimide resin may have an imidization proportion of 45% or more and 65% or less, or 50% or more and 60% or less. When the imidization proportion is within the above-mentioned range, the optical member obtained by injection molding of the glutarimide resin has a low retardation in the initial stage of molding, an increase in the retardation over time is easily suppressed, and transparency and processability are also excellent.

From the viewpoint of further enhancement of the heat resistance of the optical member, the glutarimide resin also may contain a repeating unit in which R³ is a hydrogen atom and a repeating unit in which R³ is a methyl group in the general formula (1). Such a glutarimide resin can be obtained by using ammonia as the imidizing agent described below. In this case, the imidization proportion of the glutarimide resin may be 40% or more and 70% or less, or 50% or more and 65% or less. When the imidization proportion is within the above-mentioned range, the optical member obtained by injection molding of the glutarimide resin has a low retardation in the initial stage of molding, an increase in the retardation over time is easily suppressed, and heat resistance, transparency and processability are also excellent.

From the viewpoint of heat resistance and transparency, the glutarimide resin may contain the repeating unit represented by the general formula (1) in a proportion of 30% by weight or more, 30% by weight or more and 60% by weight or less, or 35% by weight or more and 55% by weight or less.

From the viewpoint of heat resistance and transparency, the glutarimide resin may contain the repeating unit represented by the general formula (2) in a proportion of 60% by weight or less, 25% by weight or more and 60% by weight or less, or 30% by weight or more and 55% by weight or less.

From the viewpoint of the photoelastic coefficient, heat resistance and mechanical strength, the glutarimide resin may contain the repeating unit represented by the general formula (3) in a proportion of 10% by weight or more, 10% by weight or more and 25% by weight or less, or 10% by weight or more and 20% by weight or less.

The glutarimide resin may further contain another unit in addition to the repeating units represented by the general formulae (1) to (3). The content of the other unit may be 20% by weight or less, 10% by weight or less, or 5% by weight or less.

Examples of the other unit include units derived from amide-based monomers such as acrylamide and methacrylamide; units derived from nitrile-based monomers such as acrylonitrile and methacrylonitrile; units derived from maleimide-based monomers such as maleimide, N-methylmaleimide, N-phenylmaleimide, and N-cyclohexylmaleimide; and the like. These other units may be directly copolymerized in or graft copolymerized to the glutarimide resin.

The glutarimide resin is not particularly limited, but may have a weight average molecular weight (Mw) of 10,000 or more and 500,000 or less, 50,000 or more and 300,000 or less, or more and 200,000 or less, or 50,000 or more and 150,000 or less. Within the above-mentioned range, molding workability and mechanical strength of the molded body are improved, and the retardation of the optical member obtained by injection molding of the glutarimide resin tends to be low.

The optical member of one or more embodiments of the present invention is not particularly limited, and examples thereof include an optical lens, an optical cover lens, a liquid crystal display, a micro-display, a light guide plate for liquid crystal (e.g., for laser polarized backlight), an optical fiber, a microlens array, a gradient index lens, a Fresnel lens, a prism, a Fresnel rhomb retarder, and a polarizing beam splitter. In particular, one or more embodiments of the present invention can be suitably applied to optical lenses including a VR lens and an AR lens as well as a display such as an in-vehicle display, which require high image quality. In particular, the glutarimide resin having a repeating unit derived from styrene has a high refractive index, and thus the glutarimide resin can be suitably used for optical lenses which require a high refractive index.

Examples of the optical lens include a spherical lens, an aspherical lens, a biconvex lens, a planoconvex lens, a convex meniscus lens, a biconcave lens, a planoconcave lens, and a concave meniscus lens.

Examples of products using the optical member include: head mounted displays, AR smart glasses, smartphones, cameras, projectors, optical connectors, CD players, DVD players, MD players, monitoring cameras, optical switches, automotive headlights, automotive tail lamps, head-up displays, automotive meter covers, center information displays, car navigation devices, automotive optical sensors, laser oscillation devices, photonic crystal devices, 3D hologram displays, biometric authentication systems, quantum cryptography communication systems, optical arithmetic systems, semiconductor manufacturing equipment, artificial satellites, telescopes, glasses, contact lenses, endoscope lenses, road transparent noise barriers, pair glass lenses, illumination lenses, and illumination covers.

The shape of the optical member is not particularly limited, and can be appropriately set according to the application and the like. In one or more embodiments of the present invention, the optical member may have a shape susceptible to stress. Examples of the shape in which stress is likely to be generated include a thick shape, a shape with non-uniform thickness, a shape without isotropy, and a shape with a curved surface. Even when the optical member has a shape susceptible to such stress, the optical member of one or more embodiments of the present invention has a low retardation in the initial stage of molding and suppresses an increase in the retardation over time.

The average value of retardation of the optical member may be 20 nm or less, 15 nm or less, 10 nm or less, or 5 nm or less. This improves the image quality of the optical member. In one or more embodiments of the present invention, the “average value of retardation” refers to an area average value of retardation on the image display surface of the optical member. In one or more embodiments of the present invention, the “average value of retardation” may be measured as described below.

The optical member may have a retardation at the gate portion of 30 nm or less, 25 nm or less, 20 nm or less, or 15 nm or less from the viewpoint of image quality. In the injection molded article, although retardation in the periphery of the gate portion typically tends to increase, in one or more embodiments of the present invention, the retardation at the gate portion is likely to be reduced because the glutarimide resin having an orientation birefringence close to 0 was injection molded. In one or more embodiments of the present invention, the retardation at the gate portion may be measured as described below.

The thickness of the optical member is not particularly limited, and can be appropriately set according to the application and the like. In the case of the optical lens, for example, it may be 0.01 mm or more and 100 mm or less, 0.1 mm or more and 50 mm or less, 0.5 mm or more and 30 mm or less, or 1 mm or more and 20 mm or less.

The radius of curvature of the optical member is not particularly limited, and can be appropriately set according to the application or the like. In the case of the optical lens, for example, the radius of curvature may be 0.1 mm or more and 10,000 mm or less, or 1 mm or more and 500 mm or less. When the optical member is a display, it may be 1 mm or more and 50,000 mm or less, 10 mm or more and 10,000 mm or less, or 10 mm or more and 5,000 mm or less.

From the viewpoint of excellent transparency, the optical member may have a total light transmittance of 80% or more, 85% or more, or 90% or more. From the viewpoint of excellent transparency, the haze may be 2.0% or less, 1.5% or less, or 1.0% or less. In one or more embodiments of the present invention, the total light transmittance can be measured as described below.

From the viewpoint of high heat resistance and difficulty in thermal deformation, the optical member may have load deflection temperature of 120° C. or higher, 125° C. or higher, 130° C. or higher, or 135° C. or higher. In one or more embodiments of the present invention, the load deflection temperature can be measured as described below.

From the viewpoint of excellent long-term durability under high-temperature and high-humidity conditions, the optical member may have a dimensional change ratio of 0.50% or less, 0.45% or less, or 0.40% or less after being left for 1,000 hours in an atmosphere at temperature of 85° C. and a relative humidity of 85%. In one or more embodiments of the present invention, the dimensional change ratio can be measured as described below.

### (Manufacturing Method of Optical Member)

In one or more embodiments of the present invention, the optical member can be prepared by reacting a copolymer containing a repeating unit represented by the general formula (2) and a repeating unit represented by the general formula (3) with an imidizing agent; injection molding a resin composition containing the resulting glutarimide resin; and annealing the obtained injection molded article. The copolymer containing a repeating unit represented by the general formula (2) and a repeating unit represented by the general formula (3) may be simply referred to as “(meth)acrylic acid ester-aromatic vinyl copolymer”.

In the (meth)acrylic acid ester-aromatic vinyl copolymer, as the (meth)acrylic acid ester-based monomer and the aromatic vinyl-based monomer, those described above can be appropriately used. As the (meth)acrylic ester-aromatic vinyl copolymer, a methyl methacrylate-styrene copolymer containing a unit derived from methyl methacrylate (monomer) and a unit derived from styrene (monomer) (hereinafter, simply referred to as a “styrene unit”) can be suitably used.

First, a glutarimide resin is obtained by reacting a (meth)acrylic acid ester-aromatic vinyl copolymer (hereinafter also referred to as a raw material resin) with an imidizing agent in order to imidize the copolymer.

The raw material resin may be any of a linear polymer, a block polymer, a core-shell polymer, a branched polymer, a ladder polymer, or a crosslinked polymer. The blockpolymer may be of an A-B type, an A-B-A type, or any other type of block polymers other than these. The core-shell polymer may consist of one core layer and one shell layer, and each of the core and the shell may be a multilayer including two or more layers.

The raw material resin can be produced, for example, by copolymerizing a (meth)acrylic acid ester monomer and an aromatic vinyl monomer by a polymerization method such as an emulsion polymerization method, an emulsification-suspension polymerization method, a suspension polymerization method, an ion polymerization method, a bulk polymerization method, or a solution polymerization method. From the viewpoint of a small amount of impurities, a continuous polymerization method such as a bulk polymerization method or a solution polymerization method is preferable. At the time of polymerization, if necessary, a polymerization initiator, a chain transfer agent, a polymerization solvent, or the like is used. The polymerization initiator, chain transfer agent, and polymerization solvent are not particularly limited, and known polymerization initiators, known chain transfer agents, and known polymerization solvents can be used.

Examples of the production method of the raw resin include, but are not limited to, production methods described in Japanese Unexamined Patent Application, Publication Nos. S57-149311, S57-153009, H10-152505, 2004-27191, and International Publication No. WO 2009/41693.

The raw material resin such as methyl methacrylate-styrene copolymer is not particularly limited, but the weight average molecular weight (Mw) may be 10,000 or more and 500,000 or less, 50,000 or more and 300,000 or less, 50,000 or more and 200,000 or less, or 50,000 or more and 150,000 or less. Within the above range, the molding processability of the glutarimide resin obtained by imidizing the raw material resin and the mechanical strength of the molded body are improved, and the retardation of the optical member obtained by injection molding the glutarimide resin tends to be low.

The raw material resin such as a methyl methacrylate-styrene copolymer may contain more than 10 mol % and 18 mol % or less, or more than 10 mol % and 15 mol % or less of the repeating unit represented by the general formula (3) such as a styrene unit. When the content of the styrene unit is within the above-mentioned range, the glutarimide resin obtained by imidizing the raw material resin has high heat resistance, and the orientation birefringence and the photoelastic coefficient are close to zero.

The imidizing agent is not particularly limited as long as it can imidize the raw material resin to form the repeating unit represented by the general formula (1). Examples of the imidizing agent include, for example, ammonia; monoalkylamines such as methylamine, ethylamine, n-propylamine, isopropylamine, n-butylamine, isobutylamine, tert-butylamine, and n-hexylamine; monocycloalkylamines such as cyclohexylamine; and monoarylamines such as aniline, toluidine, and trichloroaniline; and the like. Among them, from the viewpoint of making the orientation birefringence and photoelastic coefficient of the glutarimide resin close to zero, monoalkylamine and ammonia are preferable, and monomethylamine and ammonia are more preferable.

The glutarimide resin obtained by imidizing a raw material resin such as methyl methacrylate-styrene copolymer with monoalkylamine is excellent in water absorption resistance. In this case, the raw material resin may contain more than 10 mol % and 18 mol % or less, more than 10 mol % and 15 mol % or less, or more than 10 mol % and 13 mol % or less of the repeating unit represented by the general formula (3) such as a styrene unit.

The glutarimide resin obtained by imidizing a raw material resin such as a methyl methacrylate-styrene copolymer with ammonia has a high glass transition temperature and excellent heat resistance. In this case, the raw material resin may contain more than 10 mol % and 18 mol % or less, or 12 mol % or more and 16 mol % or less, of the repeating unit represented by the general formula (3) such as a styrene unit.

An aqueous ammonia solution may be used as ammonia. The concentration of the aqueous ammonia solution is not particularly limited, but may be 25% by weight or more and 35% by weight or less in consideration of availability and reactivity.

In the imidization step, the ratio of the repeating unit represented by the general formula (1), the repeating unit represented by the general formula (2), and the repeating unit represented by the general formula (3) in the obtained glutarimide resin can be adjusted by adjusting the addition ratio of the imidizing agent.

The imidizing agent can be appropriately adjusted depending on the application or required characteristics of the optical member, but from the viewpoint of heat resistance, the imidizing agent may be, for example, 0.5 parts by weight or more, or 3 parts by weight or more, based on 100 parts by weight of the raw material resin such as a methyl methacrylate-styrene copolymer. The upper limit of the imidizing agent is not particularly limited, but from the viewpoint of ease of handling, the upper limit may be 30 parts by weight or less, or 20 parts by weight or less, based on 100 parts by weight of the raw material resin such as methyl methacrylate-styrene copolymer.

In the imidizing step, in addition to the imidizing agent, a ring closing promoter (catalyst) may be added as necessary.

The method for carrying out the imidization reaction is not particularly limited, and a conventionally known method can be used. For example, an extruder or a batch reactor (pressure vessel) can be used to proceed the imidization reaction.

The extruder is not particularly limited, and for example, a single-screw extruder, a twin-screw extruder, a multi-screw extruder, or the like can be used. Among them, the twin-screw extruder may be used. Using the twin-screw extruder, it is possible to promote mixing of the raw material resin and the imidizing agent (the imidizing agent and a ring closing promoter when the ring closing promoter is used).

Examples of the twin-screw extruder include a non-intermeshing co-rotating type, an intermeshing co-rotating type, a non-intermeshing counter-rotating type, and an intermeshing co-rotating type. Among them, the intermeshing co-rotating type is preferable. Since the intermeshing co-rotating type twin-screw extruder is rotatable at a high speed, it is possible to further promote mixing of the raw material resin and the imidizing agent (the imidizing agent and a ring closing promoter when the ring closing promoter is used). The extruders exemplified above may be used alone or in series of multiple extruders. For example, a tandem type reaction extruder described in Japanese Unexamined Patent Application, Publication No. 2008-273140 can be used.

In the case of performing the imidization reaction in an extruder, a raw material resin such as a methyl methacrylate-styrene copolymer is added from a raw material feeding portion of the extruder, the resin is melted to fill the cylinder, and then an imidizing agent is injected into the extruder using an addition pump, whereby the imidization reaction can proceed in the extruder.

In this case, the temperature (resin temperature) of a reaction zone in the extruder may be 180° C. or higher and 270° C. or lower, or 200° C. or higher and 250° C. or lower. When the temperature of the reaction zone is within the above range, the imidization reaction smoothly proceeds, decomposition of the resin can be suppressed, and the optical member obtained by using the glutarimide resin has improved bending resistance. Here, the reaction zone in the extruder means a region between the injection position of the imidizing agent and a resin discharge port (die portion) in the cylinder of the extruder.

Reaction time in the reaction zone of the extruder is not particularly limited, as long as the imidization reaction may proceed, but may be, for example, 10 seconds or more, or 30 seconds or more.

Resin pressure in the extruder is not particularly limited, but may be, for example, not less than atmospheric pressure and not more than 50 MPa, or not less than 1 MPa and not more than 30 MPa from the viewpoint of cost and the like.

Instead of the extruder, for example, a reaction apparatus compatible with high viscosity, such as a horizontal twin-screw reactor such as BIVOLAK manufactured by Sumitomo Heavy Industries or a vertical twin-screw stirrer such as SUPERBLEND, manufactured by Sumitomo Heavy Industries can be suitably used.

When the glutarimide resin is produced using a batch reactor (pressure vessel), the structure of the batch reactor is not particularly limited. Specifically, it is sufficient to have a structure in which the raw material resin can be melted and stirred by heating and an imidizing agent (an imidizing agent and a ring closing promoter when the ring closing promoter is used) can be added, but it is preferable that the reactor has a structure with sufficient stirring performance. By using such a batch reactor, it is possible to prevent the resin viscosity from increasing due to the progress of the reaction, resulting in insufficient stirring. As the batch reactor having such a structure, for example, an agitation tank MAXBLEND manufactured by Sumitomo Heavy Industries can be raised.

Specific examples of the imidization method include known methods such as those described in Japanese Unexamined Patent Application, Publication Nos. 2008-273140 and 2008-274187. A step of further reacting the glutarimide resin as the raw material resin with an imidizing agent may be repeated.

When producing the glutarimide resin, in addition to the imidization step, an esterification step including treatment with an esterification agent may be included. By this esterification step, a carboxy group that was by-produced in the imidization step to be contained in the resin can be converted to an ester group. Thus, an acid value of the glutarimide resin can be adjusted within a desired range.

The acid value of the glutarimide resin is not particularly limited, but may be 0.50 mmol/g or less, or 0.45 mmol/g or less. The lower limit is not particularly limited, but may be particularly substantially 0 mmol/g (below the detection limit). When the acid value is within the above range, a glutarimide resin having excellent balance of heat resistance, mechanical properties, and moldability can be obtained. The acid value of the glutarimide resin can be determined from an amount of hydrochloric acid as follows: 0.3 g of the glutarimide resin is dissolved in 37.5 mL of methylene chloride, 37.5 mL of methanol is added, 5 mL of a 0.1 mmol % aqueous sodium hydroxide solution and several droplets of an ethanol solution of phenolphthalein are added, and reverse titration of the obtained solution is conducted using 0.1 mmol % hydrochloric acid solution to obtain an amount of hydrochloric acid required for neutralization.

The esterifying agent is not particularly limited, and examples thereof include dimethyl carbonate, 2,2-dimethoxypropane, dimethyl sulfoxide, triethyl orthoformate, trimethyl orthoacetate, trimethyl orthoformate, diphenyl carbonate, dimethyl sulfate, methyltoluene sulfonate, methyltrifluoromethyl sulfonate, methyl acetate, methanol, ethanol, methylisocyanate, p-chlorophenyl isocyanate, dimethyl carbodiimide, dimethyl-t-butylsilyl chloride, isopropenyl acetate, dimethylurea, tetramethylammonium hydroxide, dimethyldiethoxysilane, tetra-N-butoxysilane, dimethyl(trimethylsilane)phosphite, trimethyl phosphite, trimethylphosphate, tricresyl phosphate, diazomethane, ethylene oxide, propylene oxide, cyclohexene oxide, 2-ethylhexylglycidyl ether, phenylglycidyl ether, and benzylglycidyl ether. Among them, dimethyl carbonate and trimethyl orthoacetate are preferable from the viewpoint of cost and reactivity, and dimethyl carbonate is more preferable from the viewpoint of cost.

The used amount of the esterifying agent is not particularly limited, but may be 12 parts by weight or less, or 8 parts by weight or less based on 100 parts by weight of the raw material resin such as methyl methacrylate-styrene copolymer. When the amount of the esterifying agent used is within the above range, the acid value of the glutarimide resin can be adjusted to an appropriate range.

In addition to the esterifying agent, a catalyst may be used in combination. The type of the catalyst is not particularly limited, but examples thereof include aliphatic tertiary amines such as trimethylamine, triethylamine, and tributylamine. Among them, triethylamine is preferable from the viewpoint of cost, reactivity, and the like.

Similar to the imidization step, the esterification step can be performed, for example, by using an extruder or a batch reactor.

The esterification step can also be carried out only by heat treatment, without using an esterification agent. The heating treatment can be achieved by kneading and dispersing a molten resin in an extruder. When only heat treatment is performed as the esterification step, some or all of the carboxy groups by-produced in the imidization step can be converted into acid anhydride groups by a dehydration reaction of the carboxy groups and/or dealcoholizing reaction of a carboxy group in the resin and an alkyl ester group in the resin, or the like. At this time, it is also possible to use a ring closing promoter (catalyst).

In the esterification step using an esterification agent, it is also possible to allow formation of an acid anhydride group by heat treatment to simultaneously proceed.

When an extruder is used in the imidization step and the esterification step, it is preferable that a vent port capable of reducing pressure to atmospheric pressure or lower is attached to the extruder. Such a configuration enables an unreacted imidizing agent, an unreacted esterifying agent, a by-product such as methanol, or monomers, or the like to be removed.

It is also possible to install a filter at the end of the extruder for the purpose of reducing foreign matter in the glutarimide resin. It is preferable to install a gear pump before the filter in order to pressurize the glutarimide resin. As a type of the filter, a leaf disc filter made of stainless steel capable of removing foreign matter from molten resin may be used, and as a filter element, a fiber type, a powder type, or a composite type thereof may be used.

Next, a glutarimide resin composition containing the glutarimide resin is injection molded to obtain an injection molded article. Typically, in a molded body obtained by injection molding or injection press molding of a thermoplastic resin, orientation and residual strain are generated depending on the injection conditions, mold shapes, gate shapes, and the like. This generates orientation birefringence, which increases retardation. However, in one or more embodiments of the present invention, by using the glutarimide resin obtained above, an injection molded article with a small retardation can be obtained regardless of the shape or molding conditions.

The glutarimide resin composition may substantially consist of a glutarimide resin, and may optionally contain another resin and an additive in addition to the glutarimide resin.

Examples of the additive include weatherability stabilizers such as antioxidants, heat stabilizers, light stabilizers, ultraviolet absorbents, and radical scavengers; catalysts, plasticizers, lubricants, antistatic agents, coloring agents, shrink preventing agents, antimicrobial agents, deodorizing agents, and the like. These may be used alone or in combination of two or more types thereof. These additives may be molded in the form of a mixture obtained by adding these additives to the glutarimide resin in advance, or may be directly added to a molding machine when the glutarimide resin is molded.

Examples of the other resin include a crosslinked elastic body. Thereby, the mechanical strength of the glutarimide resin can be improved. The crosslinked elastic body may be a core-shell elastic body having a core layer made of a rubber-like polymer and a shell layer made of a glass-like polymer (hard polymer). The core layer made of a rubber-like polymer may have one or more layers made of the glass-like polymer, as the innermost layer or an intermediate layer.

The injection molding is not particularly limited as long as it is a molding method using a commonly known apparatus such as an injection molding machine. The injection molding machine may be vertical or horizontal. In the injection molding, a generally known molding technique can also be used. The injection molding may be injection press molding, from the viewpoint of reducing molding strain. By using a mold having a predetermined shape, an injection molded article having a predetermined shape can be obtained.

Depending on the shapes, use environments, applications, and the like of the optical member, stress strain may occur in the optical member during injection molding or external stress is likely to be applied to the optical member, in some cases. Examples of the shape in which such stress is likely to be generated include a thick shape, a shape with non-uniform thickness, a shape without isotropy, and a shape with a curved surface. In one or more embodiments of the present invention, the retardation of the optical member is easily reduced by using the above-described glutarimide resin.

In the injection molding, molding conditions may be appropriately determined based on the shapes and size of the injection molded article. For example, a cylinder temperature may be 190° C. or higher and 290° C. or lower, or 210° C. or higher and 280° C. or lower. A nozzle temperature may be 230° C. or higher and 300° C. or lower, or may be 240° C. or higher and 290° C. or lower. An injection speed may be 1 mm/sec or more and 200 mm/sec or less, or 3 mm/sec or more and 150 mm/sec or less. A mold temperature may be made lower than the glass transition temperature (Tg) of the glutarimide resin, and may be Tg-5° C. or lower, or Tg-10° C. or lower. A cooling time may 10 sec or more and 400 sec or less, or 30 sec or more and 300 sec or less.

Next, the injection molded article is annealed. Thereby, the residual strain of the injection molded article can be removed, and the retardation of the optical member can be reduced. The annealing process can be performed at temperature close to the Tg of the glutarimide resin constituting the injection molded article. The annealing process may be performed, for example, at temperature of (Tg-40° C.) or more and (Tg-5° C.) or less, (Tg-30° C.) or more and (Tg-10° C.) or less, or (Tg-25° C.) or more and (Tg-15° C.) or less.

The optical member obtained above has low retardation (average value of retardation) and a small increase in the retardation even when it is stored for a long period of time under conditions of a temperature of 23° C.±2° C. and a relative humidity of 50%±5%. When the optical member is left to stand for 29 days under conditions of a temperature of 23° C.±2° C. and a relative humidity of 50%±5%, the rate of change in retardation may be 20% or less, 15% or less, 10% or less, or 5% or less.

### EXAMPLES

Hereinafter, one or more embodiments of the present invention will be described more specifically based on the Examples. One or more embodiments of the present invention are not limited to the following Examples. In the following, “parts” and “%” mean “parts by weight” and “% by weight”, respectively, unless otherwise specified.

First, various evaluation methods will be described.

### (Average Molecular Weight)

Weight average molecular weight Mw and number average molecular weight Mn were calculated based on a standard polystyrene conversion method, using size exclusion chromatography (SEC). As a measuring apparatus, a GPC system manufactured by Waters Corporation was used. Measurement was conducted using a sample solution with a resin concentration of 0.04 g/3.5 mL, chloroform as a mobile phase under the condition of a column temperature of 35° C.

### (Imidization Proportion)

The imidization proportion was calculated using an IR (infrared spectrophotometer) as follows. Pellets of a target were dissolved in methylene chloride and an IR spectrum of the solution was measured at room temperature (23±2° C.) using Travel IR manufactured by SensIR Technologies. Using the obtained IR spectrum, the imidization proportion (Im % (IR)) was determined from the ratio of the absorption intensity (Absimide) belonging to the imide carbonyl group of 1660 cm⁻¹ relative to the absorption intensity (Absester) belonging to the ester carbonyl group of 1720 cm⁻¹, provided that the molar absorption coefficient of the ester carbonyl group and that of the imide carbonyl group were regarded as the same. Here, the “imidization proportion” refers to a proportion of the imidocarbonyl groups in the total carbonyl groups.

### (Content of Styrene Unit in Methyl Methacrylate-Styrene Copolymer)

30 mg of each resin was dissolved in heavy chloroform, and ¹H-NMR measurement of the resin was performed using ¹H-NMR BRUKER Avance III (400 MHz). A value E was obtained by dividing an area of a peak derived from OCH₃ protons of methyl methacrylate composed of two peaks around 2.7 to 3.1 ppm and around 3.4 to 3.7 ppm by 3. A value F was obtained by dividing an area of peaks derived from the aromatic ring of styrene around 6.8 to 7.3 ppm by 5. The content of styrene unit in the methyl methacrylate-styrene copolymer was calculated from the following formula:

Content (mol %) of styrene unit=(F/(E+F))×100

### (Glass Transition Temperature)

Using 5 mg of each glutarimide resin, a differential scanning calorimeter (DSC, differential scanning calorimeter DSC7020 manufactured by Hitachi High-Tech Corporation) was used to measure the glass transition temperature in a nitrogen atmosphere at a rate of the temperature rise of 10° C./min.

### (5% Weight Loss Temperature)

5 mg of each glutarimide resin was heated from room temperature at a rate of 10° C./min in a nitrogen atmosphere using a differential thermal thermogravimetric measuring apparatus (TG/DTA, STA7200 manufactured by Hitachi High-Tech Corporation). The temperature at which the heat loss (% by weight) of the glutarimide resin reached 5% was measured.

### (Orientation Birefringence)

Each glutarimide resin was dried at 90° C. for 6 hours using a hot-air dryer, and then a sheet with a thickness of 0.5 mm was produced at temperature higher than the glass transition temperature of the glutarimide resin by 60° C. using a 70T press molding machine (LM-L211A) manufactured by Shinto Metal Industries, Ltd. A sample with a width of 20 mm and a length of 100 mm was cut from the obtained sheet, and a stretched film was prepared at a stretching ratio of 100% and a temperature higher than the glass transition temperature by 5° C. A test piece with a size of 40 mm×20 mm was cut out from the center portion in the TD direction of a uniaxially two-times stretched film. Using an automatic birefringence meter (“KOBRA-WR” manufactured by Oji Scientific Instruments), in-plane retardation Re of this test piece was measured at temperature of 23±2° C., a relative humidity of 50±5%, a wavelength of 590 nm and an incidence angle of 40°. A thickness of the test piece was measured using a Digimatic Indicator manufactured by Mitutoyo Corporation at temperature of 23° C.±2° C. and a relative humidity of 50%±5%. The in-plane retardation Re was divided by the thickness of the test piece and the obtained value was defined as orientation birefringence.

### (Photoelastic Coefficient)

A test piece was cut out in a strip shape of 2 cm×9 cm from the sheet prepared at the time of orientation birefringence measurement. Using this test piece, the birefringence was measured at temperature of 23±2° C., a relative humidity of 50±5%, and a wavelength of 586.4 nm, using an automatic birefringence meter (“KOBRA-WR” manufactured by Oji Scientific Instruments). The birefringence was measured by fixing one end of the sheet, and applying no load or a load of 500 g at the other end of the sheet. The amount of change in the birefringence due to the unit stress was calculated from the obtained results and the obtained value was defined as the photoelastic coefficient.

### (Total Light Transmittance)

The total light transmittance of a test piece 1 was measured according to JIS K 7361 at temperature of 23° C.±2° C. and a relative humidity of 50%±5%, using a Haze meter HZ-V3 manufactured by Suga Test Instruments.

### (Haze)

The haze of the test piece 1 was measured according to JIS K 7136 at temperature of 23° C.±2° C. and a relative humidity of 50%±5%, using a haze meter HZ-V3 manufactured by Suga Test Instruments.

### (Load Deflection Temperature)

The load deflection temperature of a test piece 3 was measured according to ISO75 standards under a load of 1.8 MPa, using a heat distortion tester 148-HDPC manufactured by Yasuda Seiki Co., Ltd.

### (Dimensional Change Rate Due to High Temperature and High Humidity)

A test piece 2 was left for one day at temperature of 23° C.±2° C. and a relative humidity of 50%±5%. Next, the test piece 2 was left for 1,000 hours in an atmosphere at temperature of 85° C. and a relative humidity of 85% using a miniature thermostatic humidifier (PL-3KP, manufactured by ESPEC). The dimensions in the resin flow direction (MD) of the test piece before and after leaving the test piece under high-temperature and high-humidity conditions were measured using a measurement microscope (TMM-130D) manufactured by TOPCON CORPORATION, and the dimensional change rate (%)=dimension after leaving/dimension before leaving×100 was calculated.

### (Retardation)

Using a two-dimensional birefringence evaluation system WPA-200-L manufactured by Photonic Lattice, the retardation of an image display surface was measured at a measurement wavelength of 543 nm at room temperature (23° C.±2° C.) and the average value of the retardation was calculated. Specifically, the image display surface of an optical member was subjected to retardation mapping to acquire a digital image, a field of view targeted was divided into pixels, and a number average value was obtained from an absolute retardation value of each pixel. The retardation was measured after leaving the optical member at temperature of 23° C.±2° C. and a relative humidity of 50%±5% for 24 hours. This is the retardation in the initial stage of molding. When the optical member is an optical lens, as shown in FIG. 2, the retardation was measured at the gate position and at the positions of r=0, r=1/2R, and r=4/5R, provided that the radius of the lens is R and the distance from the center of the optical lens is r.

### (Rate of Change in Retardation Over Time)

After leaving the optical member (optical lens) at temperature of 23° C.±2° C. and a relative humidity of 50%±5% for 29 days, the retardation of the image display surface was measured, and the average value of the retardation was calculated. Specifically, the image display surface of the optical member was subjected to retardation mapping to acquire a digital image, the field of view targeted was divided into pixels, and the number average value was obtained from the absolute retardation value of each pixel. Then, based on the retardation P0 in the initial stage of molding and the retardation P1 after leaving it for 29 days, the rate of change in the retardation over time was calculated according to the following equation.

Rate of change (%) in retardation=(P1−P0)/P0×100

### (Water Absorption Amount)

Weight (W0) of the optical member (optical lens) in the initial stage of molding and weight (W1) of the optical member after leaving it for 29 days were measured, and the water absorption rate was calculated according to the following formula.

Water absorption (%)=(W1−W0)/W0×100

### Example 1

### <Production of Glutarimide Resin>

A resin was produced using a 40 mm Φ fully intermeshing co-rotating twin-screw extruder. An extruder having an intermeshing co-rotating twin-screw extruder with a diameter of 40 mm and L/D (ratio of length L and diameter D of the extruder) of 90 was used. The raw material resin was fed into the extruder raw material supply port using a loss-in-weight feeder (CE-T-2E manufactured by KUBOTA Co., Ltd.). The glutarimide resin was produced using methyl methacrylate-styrene copolymer (Mw: 95,000, Mn: 50,000, styrene unit 11 mol %, continuous polymerization method) as the raw material resin and monomethylamine (hereinafter also referred to as “mMA”) as the imidizing agent. At this time, the set temperature of each temperature control zone of the extruder was 240° C., the screw rotation speed was 77 rpm, and methyl methacrylate-styrene copolymer was supplied at 20 kg/hr. The supply amount of monomethylamine was 8 parts per 100 parts of the methyl methacrylate-styrene copolymer. The methyl methacrylate-styrene copolymer was fed from a hopper, melted with a kneading block and allowed to fill the extruder. Then, monomethylamine was injected from a nozzle. The reaction zone was provided with a seal ring at the end thereof and was filled with the resin. After the reaction, by-products and excessive monomethylamine were devolatilized by reducing the pressure at the vent port to −0.09 MPa. The resin (strand) discharged from the extruder was cooled in a cooling water tank and then cut by a pelletizer to obtain pellets. Here, a resin pressure gauge was provided at the extruder outlet in order to confirm the internal pressure of the extruder or check extrusion fluctuations.

### <Injection Molding>

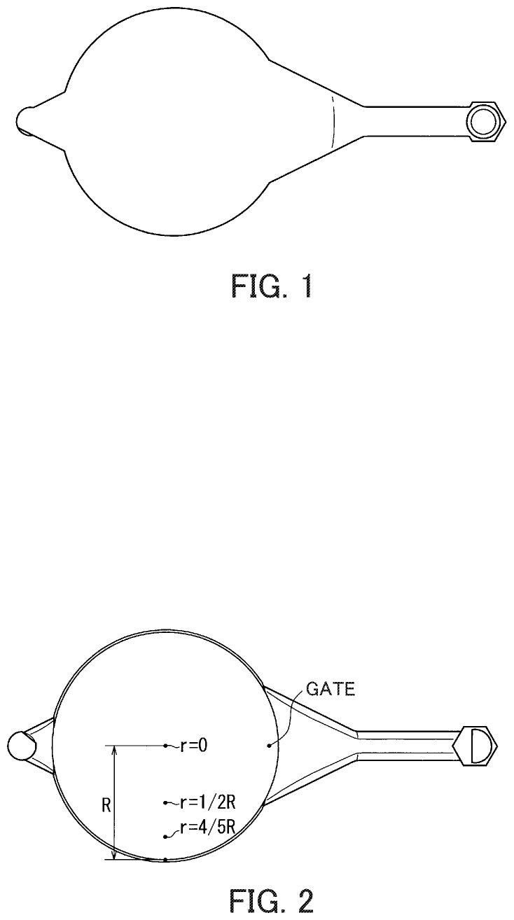

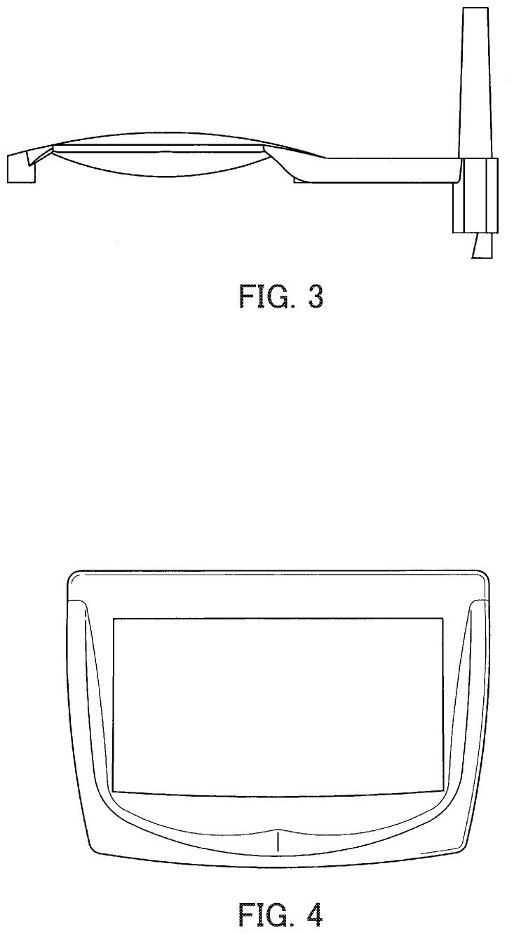

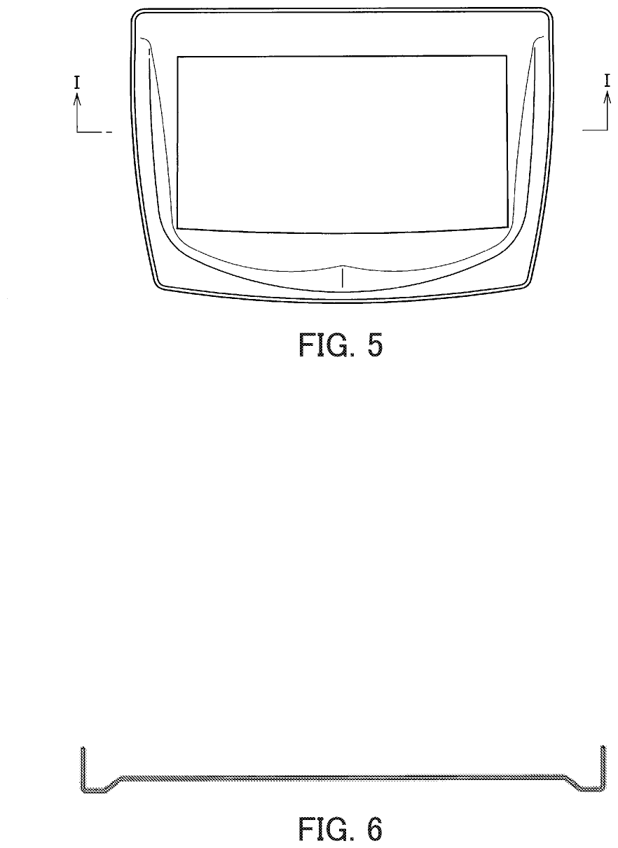

The glutarimide resin (pellet) obtained above was dried using a hot air dryer at temperature of 90° C. for 6 hours, then injection molding was performed under the molding conditions shown in Table 1, and various test pieces, optical lenses, and displays were prepared. As the injection molded article, an 80-ton injection molding machine “FN-1000” manufactured by NISSEI PLASTIC INDUSTRIAL CO., LTD. was used. The optical lens is a double-sided convex lens shown in FIGS. 1 to 3, and has a lens radius R of 48 mm, a center thickness (maximum thickness) of 9 mm, an edge thickness (minimum thickness) of 1 mm, an upper surface curvature of 0.0086 mm, an upper surface curvature radius of 116.45 mm, a lower surface curvature of 0.017 mm, and a lower surface curvature radius of 58.17 mm. The in-vehicle display has the shapes shown in FIGS. 4 to 6.

### <Annealing Process>

When the injection molded article was the test piece 2, the test piece 3, or optical lenses, annealing was performed at temperature lower than the glass transition temperature of the glutarimide resin by 15° C. for 4 hours. When the injection molded article was in-vehicle displays, annealing was performed for 4 hours at temperature lower than the glass transition temperature of the glutarimide resin by 20° C.

### Example 2

### <Production of Glutarimide Resin>

A glutarimide resin was produced in the same manner as in Example 1 except that the supply amount of monomethylamine was 10 parts per 100 parts of the raw material resin.

### <Injection Molding and Annealing Process>

Injection molding and annealing process were performed in the same manner as in Example 1 except that the glutarimide resin (pellet) obtained above was used.

### Example 3

### <Production of Glutarimide Resin>

A glutarimide resin was produced in the same manner as in Example 1 except that methyl methacrylate-styrene copolymer (Mw: 95,000, Mn: 50,000, Styrene unit: 13 mol %, continuous polymerization method) was used as the raw material resin, and the supply amount of monomethylamine was 12 parts per 100 parts of the raw material resin.

### <Injection Molding and Annealing Process>

Injection molding and annealing process were performed in the same manner as in Example 1 except that the glutarimide resin (pellet) obtained above was used.

### Example 4

### <Production of Glutarimide Resin>

A glutarimide resin was produced using an aqueous ammonia 28% by weight solution (hereinafter also referred to as “aqueous NH₃ solution”) as the imidizing agent. At this time, the extruder maximum temperature was 280° C., the screw rotation speed was 100 rpm, the supply amount of the raw material resin was 10 kg/hr, and the supply amount of the aqueous ammonia solution was 20.0 parts per 100 parts of the raw material resin. The procedure of Example 3 was repeated except for the above.

### <Injection Molding and Annealing Process>

Injection molding and annealing process were performed in the same manner as in Example 1 except that the glutarimide resin (pellet) obtained above was used and injection molding was performed under the conditions shown in Table 1 below.

### Example 5

### <Production of Glutarimide Resin>

A glutarimide resin was produced in the same manner as in Example 4 except that methyl methacrylate-styrene copolymer (Mw: 95,000, Mn: 50,000, styrene unit: 15 mol %, continuous polymerization method) was used as the raw material resin.

### <Injection Molding and Annealing Process>

Injection molding and annealing process were performed in the same manner as in Example 4 except that the glutarimide resin (pellet) obtained above was used.

### Comparative Example 1

### <Production of Glutarimide Resin>

A resin was produced using a tandem reactive extruder in which two extrusion reactors were arranged in series. With respect to the tandem type reactive extruder, an intermeshing co-rotating twin-screw extruder having a diameter of 75 mm and L/D (ratio of length L and diameter D of the extruder) of 74 was used for both the first extruder and the second extruder, and the raw material resin was supplied to the raw material supply port of the first extruder using a loss-in-weight feeder (manufactured by KUBOTA CO., LTD.). The degree of depressurization of each vent in the first extruder and the second extruder was set to −0.095 MPa. The first extruder and the second extruder were connected to each other by a pipe having a diameter of 38 mm and a length of 2 m, and a constant flow pressure valve was used as an in-component pressure control mechanism for connecting a resin discharge port of the first extruder and a raw material supply port of the second extruder. The resin (strand) discharged from the second extruder was cooled by a cooling conveyor and then cut by a pelletizer to obtain pellets. Here, resin pressure gauges were installed at the outlet of the first extruder, the center of the connecting part between the first extruder and the second extruder, and the outlet of the second extruder in order to control the pressure in the component connecting the resin discharge port of the first extruder and the raw material supply port of the second extruder or to check the extrusion fluctuations. With regard to the first extruder, an imide resin intermediate was produced using a polymethyl methacrylate (Mw: 105,000, acrylate unit: less than 0.1%, continuous polymerization method) as the raw material resin, and monomethylamine as the imidizing agent. At this time, the extruder maximum temperature was 280° C., the screw rotation speed was 55 rpm, the supply amount of the raw material resin was 450 kg/hour, and the addition amount of monomethylamine was 2.0 parts per 100 parts of the raw material resin. The constant flow pressure valve was installed immediately before the second extruder raw material supply port, and the pressure of the first extruder monomethylamine press-fitting portion was adjusted to 8 MPa. In the second extruder, the imidization reaction reagent and by-products remaining in the rear vent and the vacuum vent were devolatilized, and then a mixed solution of dimethyl carbonate and triethylamine was added as an esterifying agent, and the imide resin was prepared. At this time, the temperature of each barrel of the extruders was 260° C., the screw rotation speed was 55 rpm, the addition amount of dimethyl carbonate was 3.2 parts per 100 parts of the raw material resin, and the addition amount of triethylamine was 0.8 parts per 100 parts of the raw material resin. Further, after the esterifying agent was removed by venting, the imide resin was extruded from a strand die, cooled in a water tank, and pelletized by a pelletizer to obtain a glutarimide resin.

### <Injection Molding and Annealing Process>

Injection molding and annealing process were performed in the same manner as in Example 1 except that the glutarimide resin (pellet) obtained above was used.

### Comparative Example 2

### <Production of Glutarimide Resin>

A glutarimide resin was produced in the same manner as in Example 1 except that methyl methacrylate-styrene copolymer (Mw: 105,000, Mn: 55,000, styrene unit: 5 mol %, continuous polymerization method) was used as the raw material resin, and the supply amount of monomethylamine was 8 parts per 100 parts of the raw material resin.

### <Injection Molding and Annealing Process>

Injection molding and annealing process were performed in the same manner as in Example 1 except that the glutarimide resin (pellet) obtained above was used.

### Comparative Example 3

### <Production of Glutarimide Resin>

A glutarimide resin was produced in the same manner as in Example 1 except that methyl methacrylate-styrene copolymer (Mw: 105,000, Mn: 55,000, styrene unit: 20 mol %, continuous polymerization method) was used as the raw material resin, and the supply amount of monomethylamine was 13 parts per 100 parts of the raw material resin.

### <Injection Molding and Annealing Process>

Injection molding and annealing process were performed in the same manner as in Example 1 except that the glutarimide resin (pellet) obtained above was used.

### Comparative Example 4

### <Production of Glutarimide Resin>

A glutarimide resin was produced in the same manner as in Example 4 except that methyl methacrylate-styrene copolymer (Mw: 105,000, Mn: 55,000, styrene unit: 20 mol %, continuous polymerization method) was used as the raw material resin.

### <Injection Molding and Annealing Process>

Injection molding and annealing process were performed in the same manner as in Example 1 except that the glutarimide resin (pellet) obtained above was used and injection molding was performed under the conditions shown in Table 1 below.

In the Examples and the Comparative Examples, the glutarimide resins and the optical members were evaluated by the above-described evaluation method, and the results are shown in the following Tables 2 and 3.

TABLE 1

| | | Cylinder temperature (° C.) | | | | | Mold | Injection | Cooling |
|---|---|---|---|---|---|---|---|---|---|
| | | | | | | Below | temperature | rate | time |
| | Resin | Nozzle | H1 | H2 | H3 | hopper | (° C.) | (mm/sec) | (sec) |
| Test piece 1: | Examples 1 to 3, | 250 | 250 | 240 | 230 | 50 | 70 | 20 | 30 |
| 80 mm × 50 | Comparative | | | | | | | | |
| mm × 2 mm | Examples 1 to 3 | | | | | | | | |
| (thickness) | Examples 4 and 5 | 260 | 260 | 240 | 230 | 50 | 70 | 20 | 30 |
| | Comparative | 270 | 270 | 250 | 230 | 50 | 70 | 20 | 30 |
| | Example 4 | | | | | | | | |
| Test piece 2: | Examples 1 to 3, | 250 | 250 | 240 | 230 | 50 | 70 | 20 | 30 |
| 120 mm × 120 | Comparative | | | | | | | | |
| mm × 3 mm | Examples 1 to 3 | | | | | | | | |
| (thickness) | Examples 4 and 5 | 260 | 260 | 240 | 230 | 50 | 70 | 20 | 30 |
| | Comparative | 270 | 270 | 250 | 230 | 50 | 70 | 20 | 30 |
| | Example 4 | | | | | | | | |
| Test piece 3: | Examples 1 to 3, | 250 | 250 | 240 | 230 | 50 | 70 | 20 | 30 |
| 80 mm × 10 | Comparative | | | | | | | | |
| mm × 4 mm | Examples 1 to 3 | | | | | | | | |
| (thickness) | Examples 4 and 5 | 260 | 260 | 240 | 230 | 50 | 70 | 20 | 30 |
| | Comparative | 270 | 270 | 250 | 230 | 50 | 70 | 20 | 30 |
| | Example 4 | | | | | | | | |
| Optical lens | Examples 1 to 5, | 260 | 260 | 240 | 230 | 50 | 100 | 10 | 100 |
| with diameter | Comparative | | | | | | | | |
| 48 mm | Examples 1 to 3 | | | | | | | | |
| | Comparative | 270 | 270 | 250 | 230 | 50 | 100 | 10 | 100 |
| | Example 4 | | | | | | | | |
| In-vehicle | Examples 3 and 4, | 260 | 260 | 240 | 230 | 50 | 70 | 20 | 30 |
| display | Comparative | | | | | | | | |
| | Example 3 | | | | | | | | |

TABLE 2

| | | | | Examples | | | | |
|---|---|---|---|---|---|---|---|---|
| Item | | | Unit | 1 | 2 | 3 | 4 | 5 |
| Imidizing agent | | | — | mMA | mMA | mMA | Aqueous | Aqueous |
| | | | | | | | NH₂ | NH₂ |
| Content of styrene unit in raw material resin | | | mol % | 11 | 11 | 13 | 13 | 15 |
| Glutarimide | Imidization proportion | | mol % | 50 | 55 | 60 | 55 | 60 |
| resin | Glass transition temperature | | ° C. | 130.5 | 131.9 | 132.5 | 145.5 | 150.8 |
| | 5% weight loss temperature | | ° C. | 378 | 379 | 382 | 385 | 386 |
| | Orientation birefringence | | ×10⁻² | −0.03 | 0.14 | 0.07 | −0.01 | 0.17 |
| | Photoelastic coefficient | | 10⁻¹²Pa⁻¹ | −0.88 | −0.10 | 0.01 | −0.29 | 0.54 |
| | Total light transmittance | | % | 91.6 | 91.7 | 91.5 | 91.2 | 91.2 |
| | Haze | | % | 0.3 | 0.3 | 0.4 | 0.8 | 0.8 |
| Injection | Water absorption amount | | % | 0.39 | 0.39 | 0.38 | 0.43 | 0.43 |
| molded | of optical lens | | | | | | | |
| article | Retardation of | Total average | nm | 2.4 | 2.5 | 2.3 | 2.3 | 2.8 |
| | optical lens | Gate portion | | 4.1 | 7.2 | 5.3 | 3.3 | 7.8 |
| | (initial stage) | r = 0 | | 0.7 | 0.8 | 0.6 | 0.7 | 0.8 |
| | | r = ½R | | 1.2 | 1.5 | 0.9 | 0.9 | 1.1 |
| | | r = ⅘R | | 2.8 | 2.6 | 2.5 | 2.6 | 2.9 |
| | Retardation of | Total average | nm | 2.5 | 2.5 | 2.2 | 2.3 | 2.9 |
| | optical lens | Gate portion | | 4.2 | 7.0 | 5.1 | 3.5 | 8.5 |
| | (after 29 days) | r = 0 | | 0.8 | 0.9 | 0.7 | 0.7 | 0.9 |
| | | r = ½R | | 1.2 | 1.4 | 0.8 | 1.1 | 1.1 |
| | | r = ⅘R | | 3.0 | 2.8 | 2.4 | 2.5 | 3.3 |
| | Rate of change in | Total average | % | 4.2 | 0.0 | −4.3 | 0.0 | 3.6 |
| | optical lens | Gate portion | | 2.4 | −2.8 | −3.8 | 6.1 | 9.0 |
| | retardation | r = 0 | | 14.3 | 12.5 | 16.7 | 0.0 | 12.5 |
| | (after 29 days/ | r = ½R | | 0.0 | −6.7 | −11.1 | 22.2 | 0.0 |
| | initial stage) | r = ⅘R | | 7.1 | 7.7 | −4.0 | −3.8 | 13.8 |

| | | | | | | |
|---|---|---|---|---|---|---|
| Retardation in in-vehicle | nm | — | — | 3.5 | 2.8 | — |
| display (initial stage) | | | | | | |
| Load deflection temperature | ° C. | 124 | 125 | 125 | 136 | 137 |
| Dimensional change rate | % | — | 0.37 | 0.38 | — | — |
| after high temperature | | | | | | |
| high humidity test | | | | | | |

TABLE 3

| | | | | Comparative Examples | | | |
|---|---|---|---|---|---|---|---|
| Item | | | Unit | 1 | 2 | 3 | 4 |
| Imidizing agent | | | — | mMA | mMA | mMA | Aqueous |
| | | | | | | | NH₂ |
| Content of styrene unit in raw material resin | | | mol % | 0 | 5 | 20 | 20 |
| Glutarimide | Imidization proportion | | mol % | 10 | 50 | 65 | 70 |
| resin | Glass transition temperature | | ° C. | 123.6 | 132.9 | 131.2 | 164.7 |
| | 5% weight loss temperature | | ° C. | 362 | 372 | 378 | 394 |
| | Orientation birefringence | | ×10⁻² | −0.01 | 0.69 | −0.61 | 0.63 |
| | Photoelastic coefficient | | 10⁻¹²Pa⁻¹ | −4.00 | −1.96 | −1.53 | 2.49 |
| | Total light transmittance | | % | 92.1 | 91.8 | 91.1 | 91.0 |
| | Haze | | % | 0.5 | 0.3 | 0.7 | 1.0 |
| Injection | Water absorption amount | | % | 0.38 | 0.38 | 0.36 | 0.40 |
| molded | of optical lens | | | | | | |
| article | Retardation of | Total average | nm | 2.4 | 7.3 | 6.2 | 7.8 |
| | optical lens | Gate portion | | 3.5 | 69 | 58 | 67 |
| | (initial stage) | r = 0 | | 0.8 | 1.8 | 1.5 | 2.1 |
| | | r = ½R | | 1.1 | 5.3 | 4.3 | 5.5 |
| | | r = ⅘R | | 3.5 | 11 | 9.4 | 13 |
| | Retardation of | Total average | nm | 9.5 | 9.8 | 7.8 | 10.2 |
| | optical lens | Gate portion | | 11 | 75 | 62 | 74 |
| | (after 29 days) | r = 0 | | 0.8 | 2.4 | 1.6 | 2.6 |
| | | r = ½R | | 3.1 | 7.5 | 5.4 | 7.5 |
| | | r = ⅘R | | 12 | 15 | 11 | 19 |
| | Rate of change in | Total average | % | 295.8 | 34.2 | 25.8 | 30.8 |
| | optical lens | Gate portion | | 214.3 | 8.7 | 6.9 | 10.4 |
| | retardation | r = 0 | | 0.0 | 33.3 | 6.7 | 23.8 |
| | (after 29 days/ | r = ½R | | 181.8 | 41.5 | 25.6 | 36.4 |
| | initial stage) | r = ⅘R | | 242.9 | 36.4 | 17.0 | 46.2 |

| | | | | | |
|---|---|---|---|---|---|
| Retardation in in-vehicle display | nm | 2.7 | 35 | — | — |
| (initial stage) | | | | | |
| Load deflection temperature | ° C. | 114 | 125 | 124 | 156 |
| Dimensional change rate after | % | 0.62 | — | — | — |
| high temperature high humidity test | | | | | |

As can be seen from Tables 2 and 3, in the case of the Examples, the retardation of the injection molded article in the initial stage of molding was low, and the retardation at the gate portion was also low. Further, an increase in the retardation after leaving each injected molded body for a long period of time was suppressed. On the other hand, in the case of Comparative Example 1 in which a styrene unit was not included, the glass transition temperature was lower than 125° C., and the absolute value of the photoelastic coefficient was greater than 3.0×10⁻¹² Pa⁻¹, the retardation in the initial stage of molding of the injection molded article was low. However, the retardation significantly increased after the injection molded article had been left to stand for a long time. Further, in Comparative Examples 2 to 4, in which the absolute value of the photoelastic coefficient was large and the absolute value of the orientation birefringence was larger than 0.5×10⁻³, the retardation at the gate portion of the injection-formed body was high and the retardation in the initial stage of molding was low. However, the retardation significantly increased after the injection molded article had been left to stand for a long time.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. An optical member composed of an injection molded article,
the injection molded article comprising a glutarimide resin,
the glutarimide resin comprising a repeating unit represented by the following general formula (1), a repeating unit represented by the following general formula (2), and a repeating unit represented by the following general formula (3),
the glutarimide resin having an orientation birefringence of −0.5×10⁻³ or more and 0.5×10⁻³ or less, a photoelastic constant of −3.0×10⁻¹² Pa⁻¹ or more and 3.0×10⁻¹² Pa⁻¹ or less, and a glass transition temperature of 125° C. or more,
the optical member having an average retardation of 20 nm or less: 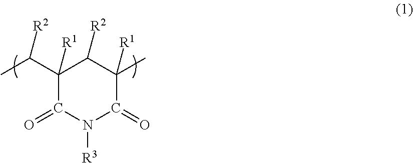
wherein R¹ and R² each independently represent a hydrogen atom or an alkyl group having 1 to 8 carbon atoms, and R³ represents a hydrogen atom, an alkyl group having 1 to 18 carbon atoms, a cycloalkyl group having 3 to 12 carbon atoms, or an aryl group having 6 to 10 carbon atoms, 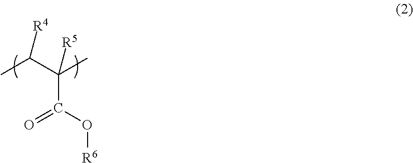
wherein R⁴ and R⁵ each independently represent a hydrogen atom or an alkyl group having 1 to 8 carbon atoms, and R⁶ represents an alkyl group having 1 to 18 carbon atoms, a cycloalkyl group having 3 to 12 carbon atoms, or an aryl group having 6 to 10 carbon atoms, and 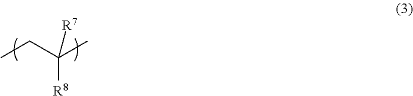
wherein R⁷ represents a hydrogen atom or an alkyl group having 1 to 8 carbon atoms, and R⁸ represents an aryl group having 6 to 10 carbon atoms.

2. The optical member according to claim 1, wherein the glutarimide resin has a 5% weight loss temperature of 350° C. or more.

3. The optical member according to claim 1, wherein the glutarimide resin has an imidization ratio of 40% or more and 70% or less.

4. The optical member according to claim 1, wherein the glutarimide resin comprises the repeating unit represented by the general formula (1) in which R³ is a methyl group, and an imidization ratio is 45% or more and 65% or less.

5. The optical member according to claim 1, wherein the glutarimide resin comprises the repeating unit represented by the general formula (1) in which R³ is a hydrogen atom and the repeating unit represented by the general formula (1) in which R³ is a methyl group, and an imidization ratio is 40% or more and 70% or less.

6. The optical member according to claim 1, wherein the optical member has a retardation of 30 nm or less at a gate portion.

7. The optical member according to claim 1, wherein the optical member is an optical lens or an in-vehicle display.

8. A method of manufacturing the optical member according to claim 1, the method comprising:
obtaining the glutarimide resin by reacting a copolymer comprising a repeating unit represented by the following general formula (2) and a repeating unit represented by the following general formula (3), with an imidization agent;
obtaining the injection molded article by injection molding a glutarimide resin composition comprising the glutarimide resin; and
annealing the injection molded article: 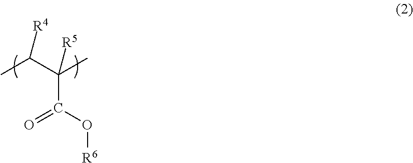
wherein R⁴ and R⁵ each independently represent a hydrogen atom or an alkyl group having 1 to 8 carbon atoms and R⁶ represents an alkyl group having 1 to 18 carbon atoms, a cycloalkyl group having 3 to 12 carbon atoms, or an aryl group having 6 to 10 carbon atoms, 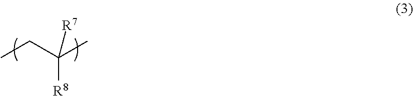
wherein R⁷ represents a hydrogen atom or an alkyl group having 1 to 8 carbon atoms, and R⁸ represents an aryl group having 6 to 10 carbon atoms.

9. The method of manufacturing the optical member according to claim 8, wherein the copolymer comprises more than 10 mol % and 18 mol % or less of the repeating unit represented by the general formula (3).

10. The method of manufacturing the optical member according to claim 8, wherein the imidization agent is monomethylamine or ammonia.

11. The method of manufacturing the optical member according to claim 8,
wherein the injection molded article has a rate of change in retardation of 20% or less, the rate of change in retardation being expressed by the following formula:
rate of change (%) in retardation=(P1−P0)/P0×100,
where:
an average retardation measured after leaving an annealed injection molded article at temperature of 23±2° C. and relative humidity of 50±5% for 24 hours is P0, and
an average retardation measured after leaving an annealed injection molded article at temperature of 23±2° C. and relative humidity of 50±5% for 29 days is P1.

12. The optical member according to claim 2, wherein the glutarimide resin has an imidization ratio of 40% or more and 70% or less.

13. The optical member according to claim 2, wherein the glutarimide resin comprises the repeating unit represented by the general formula (1) in which R³ is a methyl group, and an imidization ratio is 45% or more and 65% or less.

14. The optical member according to claim 2, wherein the glutarimide resin comprises the repeating unit represented by the general formula (1) in which R³ is a hydrogen atom and the repeating unit represented by the general formula (1) in which R³ is a methyl group, and an imidization ratio is 40% or more and 70% or less.

15. The optical member according to claim 2, wherein the optical member has a retardation of 30 nm or less at a gate portion.

16. The optical member according to claim 2, wherein the optical member is an optical lens or an in-vehicle display.

17. The optical member according to claim 1, wherein a thickness of the optical member is 0.5 mm or more and 30 mm or less.

18. The optical member according to claim 2, wherein a thickness of the optical member is 0.5 mm or more and 30 mm or less.

19. The method of manufacturing the optical member according to claim 9, wherein the imidization agent is monomethylamine or ammonia.
